(19) United States
(12) Patent Application Publication
(10) Pub. No.: US 2008/0174041 A1
(43) Pub. Date: Jul. 24, 2008

(54) Concrete block making machine and method

(76) Inventors: Douglas Keller Firedman, East Greenville, PA (US); Joseph Francis McLaughlin, Jaminson, PA (US)

Correspondence Address: Chipo M. Jolibois, Esq., Suite 301, 3 Neshaminy Interplex, Trevose, PA, 19053, US

(21) Appl. No.: 11/656,572

(22) Filed: Jan. 23, 2007

(51) Int. Cl. B28B 1/08; B28B 21/02

(52) U.S. Cl. 264/71; 425/432

(57) ABSTRACT

A method for manufacturing decorative concrete blocks for decorative garden walls is presented, along with a machine suitable for practicing the method.

### BACKGROUND

The present invention relates to a method for manufacturing decorative concrete blocks, and a machine suitable for practicing the method.

Concrete masonry blocks are commonly used for landscaping purposes. Such blocks are used to create, for example decorative garden walls having various sizes and designs. Concrete masonry blocks are typically made in high speed production plants, and they are usually uniform in appearance. This is not an undesirable characteristic in some landscaping applications, however it is a drawback in many applications where there is a demand for building blocks having a natural appearance.

One way to make concrete masonry blocks less uniform, and more natural appearing, is to use a splitting process to create a “rock face” on the block. Typically, in this process, a large concrete workpiece which has been adequately cured is split or cracked apart to form two blocks. The resulting faces of the two blocks along the plane of the splitting or cracking are textured and irregular, so as to appear rock-like. Splitting may be accomplished by manual means, such as by using a hammer and chisel. Alternatively, splitting may be performed by automated equipment. Such equipment typically includes a supporting table and opposed, hydraulically actuated splitting blades, which are usually made of steel. The blades are typically arranged so that the knife edges will engage the top and bottom surfaces of the workpiece in a perpendicular relationship with those surfaces, and arranged in a coplanar relationship with each other. In operation, the workpiece is moved onto the supporting table and between the blades. The blades are brought into engagement with the top and bottom surfaces of the workpiece. An increasing force is exerted on each blade, urging the blades toward each other. As the forces on the blades are increased, the workpiece splits (cracks), generally along the plane of alignment of the blades.

Splitting machines are useful for the high-speed processing of blocks having a rock-face finish. No two faces resulting from this process are identical, resulting in blocks having a more natural appearance than the standard non-split blocks. However, a disadvantage associated with blocks prepared by the splitting process is that the edges of the faces resulting from the industry-standard splitting process are generally well-defined (i.e. regular and sharp), and the non-split surfaces of the blocks, which are sometimes in view in landscaping applications, are regular, shiny, and non-textured. The edges therefore undesirably have a machine-made appearance.

There are known methods for making concrete blocks, including blocks that have undergone the splitting process, appear more natural looking by removing the regular, sharp edges described hereinabove. One such process is known as tumbling. In this process, a relatively large number of blocks are loaded into a drum which is rotated around a generally horizontal axis. As the drum is rotated, the blocks bang against each other, knocking off their sharp edges, and also chipping and scarring the edges and faces of the blocks, making them look less machine manufactured, and more weathered. Unfortunately, there are several drawbacks to the use of tumbling processes. First, the tumbling process is costly. The blocks must be very strong before they can be tumbled, therefore they typically must sit for several weeks after they have been formed to gain adequate strength to withstand being tumbled. This means that they must be assembled into cubes, typically on wooden pallets, and transported away from the production line for the necessary storage time. They must then be transported to the tumbler, removed from the pallets, processed through the tumbler, re-cubed and again placed on pallets. This extensive off-line processing is expensive for the concrete block manufacturer. An additional expense arises due to the substantial spoilage of blocks that can occur as the blocks break apart in the tumbler. Further, the tumbling equipment itself tends to be quite expensive, and is a high maintenance item.

Another method for removing the sharp, regular edges of concrete blocks, and distressing the face of the blocks, is to use a hammermill-type machine. In this type of machine, rotating hammers or other tools attack the surface of the block, chipping away pieces of it. These machines are typically expensive, and they require space on the production line, which space is often not available in block plants, particularly older plants. Use of this machine also, often slows down production. The process is time consuming in part because each block must typically be manipulated by flipping, rotation or other methods to attack each of its edges, and the concrete block manufacturing process can only move as fast as the hammermill can operate on each block. Additionally, use of the hammermill-type machine creates many of the inefficiencies described herein-above with regard to tumbling.

While blocks made by the abovementioned conventional methods are more natural in appearance than the standard non-split blocks, they remain very different in appearance as compared to natural rock. Therefore, there remains a need for a process and related equipment to make blocks whose appearance is closer to that of a natural rock, without the disadvantages associated with conventional methods for manufacturing decorative concrete blocks.

### SUMMARY OF THE INVENTION

The first aspect of the invention provides a method for making decorative concrete blocks, said method comprising the steps of: (i) providing at least one mold box comprising at least one chamber, the chamber having a horizontal plane which horizontal plane has a horizontal chamber surface area; wherein said mold box has a top surface, a bottom surface and at least one side surface; (ii) placing at least a portion of at least one liner in said chamber wherein said liner comprises a top surface, a bottom surface, at least one side surface, and a horizontal plane, which horizontal plane has a horizontal liner surface area, wherein the top surface of said liner is below the top surface of said mold box; (iii) providing a base plate comprising a top surface, a bottom surface and at least one side surface; (iv) contacting at least a portion of the bottom surface of said mold box with at least a portion of the top surface of said base plate; (v) placing a dry-cast concrete mix in said chamber to form an unmolded concrete block comprising a top surface, bottom surface, and at least one side surface; (vi) causing said mold box to vibrate; (vii) contacting pressurized gas with at least one of, at least a portion of the bottom surface of said liner, or at least a portion of at least one side surface of said liner; (viii) removing said molded concrete block from said mold box; and (ix) curing or allowing to cure said molded concrete block to form at least one cured concrete block.

The second aspect of the invention provides a decorative concrete block making machine, said machine comprising a bottom assembly and an optional top assembly, wherein said bottom assembly comprises: (i) a vibration table comprising a top surface, a bottom surface, and at least one side surface; (ii) a base plate comprising a top surface, a bottom surface, and at least one side surface, wherein at least a portion of said base plate bottom surface is capable of contacting with at least a portion of the top surface of said vibration table, wherein said base plate comprises at least one bore extending from at least one of said base plate bottom surface or said base plate side surface to said base plate top surface, and wherein said base plate top surface comprises at least one base plate groove; (iii) at least one mold box comprising a top surface, a bottom surface and at least one side surface, wherein at least a portion of said bottom surface of said mold box is capable of being contacted with at least a portion of the top surface of said base plate, wherein said mold box comprises at least one chamber, the chamber having a horizontal plane, which horizontal plane has a horizontal chamber surface area, (iv) at least one device capable of contacting at least a portion of the bottom surface of said mold box with at least a portion of the top surface of said base plate; (v) at least one liner comprising a top surface, a bottom surface and at least one side surface, wherein at least a portion of the bottom surface of said liner is capable of contacting with at least a portion of the top surface of said base plate, (vi) at least one pressurized gas supplying equipment capable of providing pressurized gas which pressurized gas is capable of contacting with at least a portion of at least one of, at least one side surface, or the bottom surface, of said liner; and wherein said optional top assembly comprises: at least one plunger comprising a bottom surface and at least one side surface, said bottom surface comprising a bottom surface area, wherein said plunger bottom surface is capable of at least one of (1) being contacted with at least a portion of the top surface of said mold box, (2) being suspended above said mold box, and (3) being positioned within said mold box chamber.

### BRIEF DESCRIPTION OF THE DRAWINGS

FIG. 1 is a front perspective of a concrete-making machine where the mold box is in contact with the base plate, and the plungers are in the raised position.

FIG. 2 is a front perspective of a concrete-making machine where the mold box is in contact with the base plate, and the plungers are in the lowered position

FIG. 3 is a front perspective of a concrete-making machine where the plungers are in the lowered position, and the mold box is not in contact with the base plate.

FIG. 4 is a front perspective of a concrete-making machine where the mold box is not in contact with the base plate, and the plungers are in the raised position.

FIG. 5 is a side perspective of the bottom assembly of a concrete-making machine.

FIG. 6 is a side perspective of the top assembly of a concrete-making machine.

FIG. 7 is a top elevated perspective of a base plate.

FIG. 8 is a top elevated perspective of a base plate having liners on its top surface.

FIG. 9 is a top elevated perspective of an anchor plate.

FIG. 10 is a side elevated perspective of a mold box.

FIG. 11 is an exploded perspective of a mold box, concrete blocks, liners, base plate and anchor plate.

FIG. 12 is side elevated perspective of a mold box.

FIG. 13 is an elevated perspective of a concrete block.

### DETAILED DESCRIPTION OF THE INVENTION

While this invention is susceptible of embodiments in many different forms, the drawings shown and the specification describe in detail several embodiments of the invention. It should be understood that the drawings and the specification are to be considered an exemplification of the principles of the invention. They are not intended to limit the broad aspects of the inventive method and related equipment to the embodiments illustrated.

The present invention provides a method for making decorative concrete blocks, and related equipment for performing the method. Applicants' invention provides a method and related equipment that do not suffer from at least one of the disadvantages of conventional decorative concrete block making methods and equipment. Applicants' method has at least one of the following attributes: creates a more natural rock face appearance to the faces of decorative concrete wall blocks, by among other things, eliminating the regular, sharp face edges that result from the industry-standard splitting process, does not slow down the concrete block production line, is less costly than conventional block making equipment, does not require significant additional space on the production line, and is less labor intensive than conventional wet-cast methods.

The first and second aspects of the invention are described below in detail. An in-depth description of the components of the equipment of the invention are incorporated within the discussion of the method of the invention. The method of the invention, which is the first aspect of the invention, involves a variety of steps. The order of the steps is not important, as long as the steps are performed in an order that provides for a decorative concrete block suitable for use to make decorative walls, such as for example, decorative garden walls. In one step of the invention, a mold box is provided. The exterior of the mold box has a top surface, a bottom surface and at least one side surface. The mold box may be made of any material that is capable of being in contact with dry-cast concrete without rusting, and that is strong enough for repeated use in the method of the invention. Suitable materials of construction for the mold box include but are not limited to metals, such as for example, stainless steel, hardened steel, aluminum, and the like. Materials such as wood and plastic and the like are not preferred, as they are not sufficiently strong. The mold box is not solid throughout. Rather, it has at least one hollow portion extending from the mold box top surface to the mold box bottom surface. This hollow portion forms the mold box chamber. The portion of the mold box surrounding the chamber forms the chamber walls. Each chamber wall has a chamber wall thickness. The mold box may have one or more chambers. Where it is desired to make multiple concrete blocks simultaneously, the mold box has more than one chamber. The shape of the mold box chamber may vary depending upon the desired shape of the concrete block made according to the method of the invention. The shape of the mold box chamber may enable the manufacture of concrete blocks having different faces that are uniform, or different in height, length or width. In one embodiment of the invention, the mold box may enable manufacture of concrete blocks whose back face height may be higher than that of the front face of the concrete block. For optimal stacking it is preferred that the concrete block back face be only slightly higher than the front face, and, it is more preferred that the front and back faces have the same height. By “front face” is meant herein the block face bearing a decorative design, preferably a design similar to that of a natural rock face. By “back face” is meant herein the concrete block face that is located opposite to the front face. In one embodiment of the invention, the shape of the mold box chamber is such that it is able to provide concrete blocks having a shape that makes them suitable for use in the curved portions of a decorative wall. In this embodiment, it is preferred that the mold box shape is such that it enables manufacture of concrete blocks whose back face width is shorter than that of the front face of the concrete block, so that the blocks have some “frontal taper”. By “frontal taper” is meant herein the angle created by the difference between the width of the decorative front face of the concrete block and that of the back face. Preferably, the concrete blocks of this embodiment have a frontal taper of 0 degrees to 45 degrees, more preferably from 0 degrees to 20 degrees, and even more preferably from 0 degrees to 10 degrees.

Each mold box chamber has a horizontal plane and a horizontal surface area. By “plane” is meant herein a cross section of the chamber. The horizontal plane of the chamber is what would be evidenced if the mold box were to be cut in a horizontal direction, where the cut passes completely through the chamber. By “horizontal surface area” is meant herein the extent of a 2-dimensional surface enclosed within the boundary of the horizontal plane of the chamber. The internal surfaces of the mold box form the chamber walls, which define the boundary of the chamber. In one embodiment of the invention, at least one chamber wall has at least one chamber wall groove. By “groove” is meant herein a furrow or channel. Preferably the chamber wall groove is located on a section of the chamber wall which may be in contact with the below-mentioned liner. Preferably, the chamber wall groove extends horizontally along the entire length of the chamber wall, more preferably, it extends along the entire length of all of the chamber walls. The chamber wall groove has a depth that is less than the thickness of the chamber wall, and that does not interfere with the structural integrity of the chamber wall. Preferably, the chamber wall groove is suitable for transporting gas along at least a portion of the chamber wall. Preferably the chamber wall groove is arranged in such a manner as to facilitate the movement of gas along at least a portion of chamber wall in such a way as to prevent or decrease the formation of a vacuum between the chamber wall and the liner. This aids in removal of the liner from the chamber. In a different embodiment of the invention, the chamber wall has at least one chamber wall bore. By “bore” is meant a hole or passage made as if by boring with a drill or other tool. Preferably, the chamber wall bore extends from at least one of, the mold box bottom surface, or the mold box side surface, to the internal surface of the chamber wall. In this embodiment, the chamber wall bore may be used to distribute gas to at least one chamber wall groove.

In a different step of the invention, at least a portion of the bottom surface of the mold box is contacted with at least a portion of at least one base plate. By “base plate” is meant herein a structure having a top surface, a bottom surface, and at least one side surface. Preferably, the base plate has a height which is substantially shorter than its width. The mold box may be contacted with the base plate by any suitable means, including but not limited to resting the full weight of the mold box on the base plate, suspending the mold box above the base plate such that some or all of the mold box is in contact base plate, and the like. Preferably, the entire bottom surface of the mold box is in contact with at least a portion of the top surface of the base plate. The mold box may be caused to contact with the base plate by the use of any suitable device, for example by use of an air powered cylinder, air over oil cylinder, electrical device, hydraulic device, hand controlled device and the like.

The base plate may be made of any material suitable for sustaining the weight of one or more concrete blocks. The configuration of the base plate top surface may be any suitable configuration. Preferably the top surface of the base plate is substantially flat. Preferably the height of the base plate is substantially uniform, more preferably uniform, throughout the length of the plate. The base plate may be removable, or it may be permanently fixed to a piece of equipment, such as for example a vibration table. Where it is desired to make successive batches of molded concrete block without having to wait for the previous batch to cure, it is preferred that the base plate be removable. This enables the removal of the uncured molded concrete blocks to a location where they can be stored for curing, while the same or a different base plate may be used to make additional concrete blocks.

In a preferred embodiment of the invention, the top surface of the base plate has at least one groove. By “groove” is meant herein a furrow or channel. The base plate groove has a depth that is less than the height of the base plate, and that does not interfere with the structural integrity of the base plate. Preferably, the base plate groove is suitable for transporting gas along at least a portion of the top surface of the base plate. In another preferred embodiment, the base plate grooves are arranged in a pattern. Preferably the groove pattern facilitates the movement of gas along at least a portion of the top surface of the base plate in such a way as to prevent or decrease the formation of a vacuum between the base plate and the below-described liner. This aids in removal of the liner from the top surface of the base plate. In yet another preferred embodiment of the invention, the groove pattern mirrors, on a reduced scale, the borders of the bottom surface of the liner. This not only serves as an indicator for placement of the liner on the base plate, but it also enables efficient movement of gas along the top surface of the base plate to prevent or diminish the above-mentioned vacuum.

In one embodiment of the invention, the base plate has at least one base plate bore. By “bore” is meant a hole or passage made as if by boring with a drill or other tool. Preferably, the base plate bore extends from at least one of the base plate bottom surface or the base plate side surface to the top surface of the base plate. The bore may have any suitable diameter. Preferably the base plate bore has a diameter of from ⅙ inch to 1 inch, more preferably from ⅜ inch to ⅜ inch, and even more preferably from ¼ inch to ⅝ inch. In this embodiment, the base plate bore may be used to distribute gas to at least one base plate groove. In a different embodiment of the invention, the top surface of the base plate may be recessed so as to provide a guide as to where the liner should be placed on the base plate. The depth of the recess may vary depending upon the depth needed for guidance and/or anchoring of the particular liner being used.

In another step of the method of the invention, a liner is placed in the chamber of the mold box. The liner may be placed in the mold box chamber by any suitable means, such as for example inserting it by hand or by machine, or by setting the liner on a surface and then placing the mold box on top of the same surface, with the chamber in alignment with the liner, so that at least a portion of the liner, preferably all of the liner, enters the mold box chamber. In a preferred embodiment, the liner is placed on the base plate, directly below the mold box chamber, and the mold box is lowered onto the base plate, until at least a portion of the liner, preferably all of the liner, is inserted in the mold box chamber. The liner has a top surface, a bottom surface, at least one side surface, a horizontal plane, and a horizontal surface area. By “plane” is meant herein a cross section of the liner. The horizontal plane of the liner is what would be evidenced if the liner were to be cut in a horizontal direction, where the cut passes completely through the liner. By “horizontal surface area” is meant herein the extent of a 2-dimensional surface enclosed within the boundary of the horizontal plane of the liner. When the liner is placed in the mold box chamber, the top surface of the liner is located below the top surface of the mold box, so that when concrete mix is poured into the mold box chamber, there is sufficient space in the chamber for a concrete block to be formed. The amount by which the top surface of the liner is below the top surface of the mold box can vary depending upon the desired concrete block depth. The horizontal liner surface area is preferably no greater than the horizontal chamber surface area, to enable the liner to be inserted in the mold box chamber. The liner may be formed from any material suitable for providing a mold for the formation of a decorative concrete block face. Examples of suitable liner materials of construction include, but are not limited to for example, rubber such as for example urethane rubber, silicone rubber, latex rubber, and the like, fiberglass, polyester resin and the like.

Preferably, the liner has a pattern on its top surface. The pattern may vary depending upon the desired pattern of decorative face of the concrete block. The pattern on the liner may be formed by any suitable method. In a preferred embodiment of the invention, the liner pattern may be formed by first creating a mold having a reverse pattern of a natural rock. The first mold may be formed by either placing the natural rock in a mold forming vessel and pouring the first mold material into the mold forming vessel, or alternatively by pouring the first mold material into the mold forming vessel, and then contacting the rock with the top surface of the first mold material. By “mold forming vessel” is meant herein any container suitable for use to prepare a mold, such as for example, a box made of wood, plastic, polyvinyl chloride, fiberglass sheeting, metal, or any other suitable nonporous material. The first mold may made of any suitable material, such as for example, rubber, fiberglass, molding wax, polyester resin, and the like. The first mold, which bears the reverse pattern of the natural rock, may be dried and then placed in the same or a different mold forming vessel. A second mold material may then be poured into the mold forming vessel, on top of the first mold, to form a second mold. The second mold bears the same pattern as the natural rock, so it may later be used as the master mold for making liners. The second mold may be made of any suitable material, such as for example, plastic, plaster, concrete and the like. The second mold may be dried and then placed in the same or a different mold forming vessel, in which it may be used to form one or more liners suitable for use in the method of the invention. The liner made according to this embodiment of the invention bears the reverse pattern of the original natural rock. Use of the liner in the method of the invention results in a decorative concrete block whose decorative face is exceedingly similar to that of a natural rock. Thus, it enables efficient manufacture of concrete blocks having a more natural rock face appearance then conventional concrete blocks.

In one embodiment of the invention, the liner top surface is at least partially coated with at least one material that can change or enhance the color concrete, such as for example, a mineral pigment, dye, and the like. The same, or several different coloring materials may be used at various locations on the liner top surface. The use of coloring materials facilitates the coloring of the face of the concrete block that is in contact with the liner during another step of the method of the invention, resulting in a more natural-looking rock face on the end-product decorative concrete block.

In a different step of the invention, a dry-cast concrete mix is placed in the mold box chamber. By “dry-cast” is meant herein a concrete mix having a low slump. By “low” is meant herein a slump of preferably no greater than 2 inches, more preferably no greater than 1.5 inches, still more preferably no greater than 1 inch, where the slump is measured according to the American Society for Testing and Materials (ASTM) Method C-143. The use of a wet-cast concrete mix is not recommended for the present invention. The use of a dry-cast mix is preferred over a wet-cast mix, as the dry-cast mix enables faster processing of decorative concrete blocks, and results in a concrete block having better non-slip qualities and greater strength, amongst other things. It is desirable that the blocks have a rough, non-slip surface at least on the block surfaces that contact with other blocks during the wall construction process, so as to prevent the blocks from sliding off of each other during and after construction of the wall. The small amounts of water in the dry-cast concrete mix enable provision of such non-slip surfaces. An additional benefit associated with use of a dry-cast concrete mix is that it provides an enhanced aesthetic effect, in that it results in a more natural looking rock face on the concrete block end-product, as well as a more natural looking top surface for blocks used to form the top layer of a decorative wall. The use of dry-cast concrete has the added advantage of decreasing the manufacturing costs and processing time for processes for making concrete blocks. Where wet-cast concrete blocks are utilized, the concrete block typically remains in a mold until it has cured. This is disadvantageous because the mold is not available for use to manufacture new concrete blocks while it must remain with the curing concrete block. This results in the concrete block manufacturer having to purchase numerous molds. Manufacturers using dry-cast concrete mixes are able to avoid much of the cost of the molds, as the molds are available for reuse soon after the concrete block has been formed into the desired shape, as the dry-cast concrete blocks can be cured without the presence of a mold. In Applicants' invention, the liner and the mold box are usable for processing additional concrete blocks soon after the molded concrete block has been formed, as the molded concrete blocks can be cured while the blocks are outside of the mold box, and not in contact with the liner.

The amount of dry-cast concrete mix placed in the chamber may vary, depending on the desired height of the concrete block. Therefore, the amount of concrete mix may be enough to fill the chamber completely or partially. It is preferred that the chamber be completely filled. Where multiple chambers are used simultaneously, it is preferred that each chamber be filled to the same capacity to enable manufacture of multiple concrete blocks having substantially the same height.

The ingredients in the concrete mix are of a type and quantity typically found in conventional concrete mixes. Preferably, the concrete mix contains a mixture of cement, at least one aggregate, and water. It is preferred that the concrete mix contain a ratio of from 10 parts aggregate to 1 part cement, more preferably from 6 parts aggregate to 1 part cement, even more preferably from 4 parts aggregate to 1 part cement. Preferably, the water is used in the concrete mix in amounts of from 6 to 10 gallons of water per 100 lbs cement, more preferably from 4 to 8 gallons of water per 100 lbs cement, even more preferably from ¾ to 3 gallons of water per 100 lbs cement. The cement may be any cement suitable for making concrete, preferably it is a Portland cement. Suitable aggregates include those typically used to make concrete, including for example, sand, gravel, crushed stone, small river stone, and the like. In a preferred embodiment of the invention, the cement mix further contains at least one additive. Suitable additives include those that provide enhanced performance of the concrete block, including but not limited to improved workability, consistency, density, strength, durability, and the like. Examples of suitable additives include, for example, coloring agents such as for example mineral pigment, air-entraining material, accelerator, water repellant, fiber, plasticizer, materials that limit efflorescence, and the like. Where a mineral pigment is used, it may be used in any suitable amount. It is preferred that mineral pigment be used in amounts of from 2% to 20% mineral pigment per 100 lbs cement, more preferably from 4% to 15% mineral pigment per 100 lbs cement, even more preferably from 5% to 6% mineral pigment per 100 lbs cement. The dry-cast concrete mix is blended using a mixer suitable for such purposes, such as for example, a pan-type mixer, spiral-blade mixer, paddle mixer, and the like. The blending may be partial or complete, as long as the resulting mixture is suitable for making concrete blocks having properties suitable for making decorative concrete walls. Preferably, the blending is performed to provide a uniform mixture.

Upon placement in the mold box chamber, the concrete mix begins to adapt the shape of the chamber, forming an unmolded concrete block having a top surface, bottom surface, and at least one side surface. In another step of the method of the invention, the mold box containing the unmolded concrete block is caused to vibrate. The vibration assists in the compaction of and removal of gas from the unmolded concrete block, among other things. The length of the vibration and the frequency of the vibration may vary. In one embodiment of the invention, the vibration is continued at least until such time as substantially all of the gas bubbles have been removed from the space between the top of the liner and the bottom of the concrete block. The length of the vibration may vary depending upon the type and quantity of the concrete mix ingredients, and the type of vibration technique utilized. Suitable vibration times are those that result in a molded concrete block that will properly cure, and which when cured, will result in a concrete block having properties that make the block suitable for use as in a decorative wall. The vibration may be caused by any suitable means, including but not limited to, use of vibration equipment such as for example a vibration table, vibration poker, or other suitable mechanical, electrical or pneumatic vibration device. A variety of such devices are commercially available. In one embodiment of the invention, a vibration table may be used to vibrate the concrete block. Suitable vibration tables are commonly available, and include for example the Table Top Vibrating Table made by Shawnee Camden Concrete Products, LCC, located in West Alexandria, Ohio. The vibration table top surface may have on at least one of its extremes, a mechanism or structure that can be used as a guide for correct placement of the base plate and/or an anchor plate. The vibration table may be constructed of any material which is strong enough to withstand the stress of the vibration and the weight of the concrete blocks. Suitable materials of construction include, for example metals, such as for example steel. The vibration table may have bores leading to the vibration table top surface. Preferably, the number of bores is same as the number of bores in the base plate and the number of bores in the optional anchor plate. This arrangement enables transportation of pressurized gas through the vibration table bores, into the optional anchor plate, and then into the bores of the base plate, for distribution of the pressurized gas onto the liner surfaces.

In one embodiment of the invention, a plunger having a bottom surface face is provided. The material of construction of the plunger may be any material that is strong enough to resist the lift of the mold box, and is capable of being in contact with dry-cast concrete without rusting such as for example, steel, stainless steel, aluminum, plastic, and the like. In one embodiment of the invention, the bottom surface of the plunger may be suspended above the top surface of the unmolded concrete block. In another embodiment of the invention, at least a portion of the bottom surface of the plunger may be contacted with at least a portion of the top surface of the unmolded concrete block. The plunger may assist in defining the shape of the back surface of the unmolded concrete block. The plunger may also assist in removal of the molded concrete block from the mold box, by holding the concrete block down while mold box is removed from the molded concrete blocks. Where the plunger is used in this manner, it is preferred that the downward pressure of the plunger on the unmolded concrete block is greater than the pressure used to lift the mold box from the molded concrete block. Preferably, the plunger is in the raised position during vibration of the mold box, and is lowered prior to release of the concrete block form the mold box chamber. In a different embodiment of the invention, the plunger may be situated in a position other than above the unmolded concrete block. For example, where the mold box has at least one removable side surface, facilitating removal of the mold box from the concrete block in a horizontal direction, the plunger may be located to the side of the mold box.

In another embodiment of the invention, at least a portion of the bottom surface of the base plate may be in contact with at least a portion of the top surface of a vibration table. In this embodiment, the base plate may be permanently attached to the vibration table, or it may be removable. In a different embodiment of the invention, at least a portion of the bottom surface of at least one different plate, an anchor plate, may be in contact with at least a portion of the top surface of a vibration table. This may be desirable, for example, where the top surface of a commercially available vibration table is not suitable for supporting the base plate of the invention. In this embodiment of the invention, at least a portion of the top surface of the anchor plate, may be in contact with at least a portion of the bottom surface of a base plate. The anchor plate, which may have a top surface, a bottom surface and at least one side surface, may be removable or it may be permanently attached to the vibration table. Preferably, it is permanently attached to the vibration table. In one embodiment of the invention, the anchor plate may have at least one bore. By “bore” is meant herein a hole or passage made as if by boring with a drill or other tool. The diameter of the anchor plate bore may be less than, equal to or greater than the diameter of the base plate bore. Preferably, the diameter of the anchor plate bore is smaller than the diameter of the base plate bore. Preferably, the anchor plate bore has a diameter of from ⅛ to ½ inch, more preferably from ⅛ to ¾ inch, and even more preferably from ¼ to ½ inch. It is preferred that the anchor plate bore be aligned with the at least one base plate bore, to facilitate transportation of pressurized gas through the anchor plate bore and the base plate bore to the top surface of the base plate. Suitable materials of construction for the anchor plate are the same as those described hereinabove as being suitable for the base plate.

In another step of the invention, pressurized gas may be contacted with at least one of, at least a portion of the bottom surface of the liner, or at least a portion of at least one side surface of the liner. In one embodiment of the invention, pressurized gas is contacted with at least a portion of the bottom surface of the liner and at least a portion of at least one side surface of the liner. In another embodiment, the pressurized gas is contacted with the entire bottom surface of the liner, and the entire bottom surface of at least one side surface of the liner. In a preferred embodiment, the bottom surface and all of the side surfaces of the liner are contacted with the pressurized gas. The gas may be any gas capable of contacting with the concrete making machine parts and concrete without damaging them or compromising their integrity, such as for example air, nitrogen, and the like. Preferably it is air. The pressure of the gas may be any suitable pressure for practicing the invention, and it may vary depending upon the temperature and consistency of the concrete mix, among other things. It is preferred that the gas have a pressure of from 50 to 150 psi (pounds per square inch), more preferably from 75 to 100 psi., even more preferably from 70 to 80 psi.

In those embodiments where the pressurized gas is contacted with the bottom surface of the liner, the gas may be transported to the bottom surface by any suitable means. Preferably, the liner is situated in a manner such that bottom surface of the liner diffuses the gas to distribute it evenly along the bottom surface of the liner. More preferably, the liner is situated in a manner such that the gas that has been evenly distributed along the bottom surface of the liner travels up the side surfaces of the liner and is evenly distributed along the liner side surfaces. In one embodiment of the invention, the transportation of the gas occurs by delivering gas to at least one groove on the top surface of the base plate. The gas may be delivered to the at base plate groove by any suitable means. In one embodiment of the invention, the gas is transported to the base plate groove by at least one base plate bore. The pressure of the gas that is contacted with the liner bottom surface may be any pressure suitable to prevent or decrease the formation of a vacuum between the bottom surface of the liner and the top surface of the base plate. This aids in the removal of the liner from the top surface of the base plate.

In those embodiments where the pressurized gas is contacted with at least one side surface of the liner, the gas may be transported to the side surface by any suitable means. Preferably, the liner is situated in a manner such that the liner diffuses the gas to distribute it evenly along the side surfaces of the liner. In one embodiment of the invention, the transportation of the gas occurs by delivering gas to at least one groove on at least one mold box chamber wall. The gas may be delivered to the at least one chamber wall groove by any suitable means. In one embodiment of the invention, the gas is transported to the chamber wall groove by at least one bore in the chamber wall. The pressure of the gas that is contacted with the liner side surface may be any pressure suitable to prevent or decrease the formation of a vacuum between the side surface of the liner and the chamber wall. This aids in removal of the liner from the mold box chamber. In any of the embodiments of the invention where pressurized gas is used, it is preferred that care be taken to ensure that the pressurized gas does not disturb any concrete mix that may be placed in the mold box chamber.

In yet another step of the invention, after the concrete block has been molded into its final shape, it is removed from the mold box. The removal may be performed by any suitable means for removal that results in minimal or no damage to the concrete block. In one embodiment of the invention, the removal is conducted by lifting the mold box above the molded concrete block, preferably in a vertical direction. The lifting may be performed by manual means, or any other suitable means such as for example by use of a mechanical, electrical or hydraulic device, an air powered cylinder, an air over oil cylinder or any other suitable means. The force with which the molded concrete block is removed from the mold box is any force suitable for performing such removal. In one embodiment, the force of removal is from 2,000 to 10,000 lbs of lift, preferably from 5,000 to 10,000 lbs of lift, more preferably from 4,000 to 8,000 lbs of lift, and even more preferably from 2,000 to 3,000 lbs of lift. In another embodiment of the invention, the removal is conducted by pushing or pulling the molded concrete block from the mold box, preferably in a horizontal direction, after removing at least one of the side walls of the mold box. In this embodiment, there may be a limitation with regard to the number of blocks that can be simultaneously made.

In one embodiment of the invention, the concrete block may be removed from the mold box while pressurized gas is contacted with at least one of, at least a portion of the bottom surface of the liner, or at least a portion of at least one side surface of the liner. The pressurized gas may he transported to the liner surfaces by at least one of the base plate bores, and the mold box bores, as described herein.

In a different step of the invention, the molded concrete block is cured or allowed to cure to form at least one cured concrete block. The curing may be conducted in any manner, and under any conditions that will result in a cured concrete block having sufficient properties, such as for example, strength, durability, impermeability, surface hardness, crack resistance and the like, for use as a decorative wall. During curing, it is preferred that the concrete block be protected from extreme temperatures and dryness. Additionally, it is preferred that the blocks undergoing curing be protected from drafts to prevent cracking due to surface moisture loss. In order for the dry-cast concrete blocks to cure properly, it is preferred that they contain an adequate amount of water during at least a portion of the curing process. To enable this, the concrete blocks may be cured under conditions that prevent the concrete blocks from drying too quickly during the curing process, such as for example curing in a controlled, moist environment. Preferably, curing is performed at temperatures of from 60° F. to 90° F., although additional heat may be added to speed up the curing process. Curing is preferably conducted in an environment having a relative humidity of from 60% to 100%. The length of the curing process may vary depending upon the amount and type of components in the concrete mix, and the curing conditions. Typical curing times may range from 4 hours to 8 hours.

In one embodiment of the invention, the molded concrete block may be sprayed during curing, on at least one of its surfaces, preferably at least on its decorative surface, with a material that may prevent water from penetrating the concrete block and/or preserve the color of the concrete block over time, such as for example a water repellant, water based sealer such as for example Krete Dura Seal, manufactured by Krete Industries, Inc., located in Butler, Wis., acrylic-styrene polymer, and the like.

The end-product concrete block is suitable for building decorative walls, such as those typically found in garden landscaping. Typically, an adhesive material, preferably a waterproof adhesive, such as a commercially available landscape block adhesive may be used to hold the blocks in place on the wall. Typically, the concrete blocks are used in garden walls have a height of 2 feet or less, although they may be higher, as long as they are not built so high as to impair the stability of the wall. Walls built using decorative concrete blocks made by the method of the invention are aesthetically pleasing, and exceedingly natural-looking.

Any machine suitable for carrying out the method of the invention may be used. As noted above, many of the characteristics of equipment suitable for the invention are described above in the description of the method of the invention. In one embodiment of the invention, the method is performed by a machine having a bottom assembly and an optional top assembly. In this embodiment, the bottom assembly has a vibration table having a top surface, a bottom surface, and at least one side surface. Suitable vibration tables are as described above in the description of the method of the invention. In this embodiment, at least a portion of the top surface of the vibration table is in contact with at least a portion of the bottom surface of a base plate. The base plate of this embodiment is either fixed or movable. It has a top surface, a bottom surface, and at least one side surface. The base plate has at least one bore extending from either the side surface of the base plate to the top surface of the base plate, or from the bottom surface of the base plate to the top surface of the base plate, or from both the base plate side surface and bottom surface to the base plate top surface. The base plate of this embodiment has at least one base plate groove on its top surface. Optionally, the bottom assembly may have an anchor plate between the base plate and the vibration table. The anchor plate, which may be fixed or removable, has a top surface, a bottom surface, and at least one side surface. There may be a bore extending from the anchor plate bottom surface to the anchor plate top surface. This embodiment of the invention also includes a mold box which has a top surface, a bottom surface and at least one side surface. At least a portion of the mold box bottom surface is capable of being contacted with at least a portion of the top surface of the base plate. The mold box contains at least one chamber. The mold box chamber has a horizontal plane, which has a horizontal chamber surface area. This embodiment of the invention further includes at least one device which is capable of causing at least a portion of the bottom surface of the mold box to contact with at least a portion of the top surface of the base plate. The device may be controlled by hand or by mechanical, pneumatic or electrical means. Suitable devices include for example, an air powered cylinder, air over oil cylinder, electrical device, hydraulic device, and the like. This embodiment of the invention has at least one liner. The liner has a top surface, a bottom surface and at least one side surface. At least a portion of the bottom surface of the liner is capable of contacting with at least a portion of the top surface of the base plate. The liner may be made to contact the base plate by any suitable means, as described in the discussion of the method of the invention above. Another component of this embodiment of the invention is at least one pressurized gas supplying equipment. The gas-supplying equipment supplies pressurized gas that is capable of contacting with at least a portion of at least one of, the side surface, or the bottom surface, of the liner. Suitable gas supplying equipment includes for example an air compressor, air blower, or any other suitable device.

In a different embodiment of the invention, the decorative concrete making machine has a top assembly having at least one plunger. The plunger has a bottom surface which has a plunger bottom surface area. The plunger bottom surface area is preferably no greater in size than the chamber horizontal surface area. The plunger bottom surface is capable of at least one of, being positioned above the mold box chamber, being contacted with at least a portion of the top surface of the mold box, or being positioned within the mold box chamber. In those embodiments of the invention where the concrete blocks are released from the mold box by raising the mold box above the concrete blocks in a vertical direction, the use of a plunger is strongly preferred, as release of the concrete block in the absence of the plunger may prove to be difficult.

For purposes of promoting an understanding of the principles of the invention, reference will be made to the exemplary embodiments illustrated in the drawings, and specific language will be used to describe the same. It will nevertheless be understood that no limitation of the scope of the invention is thereby intended.

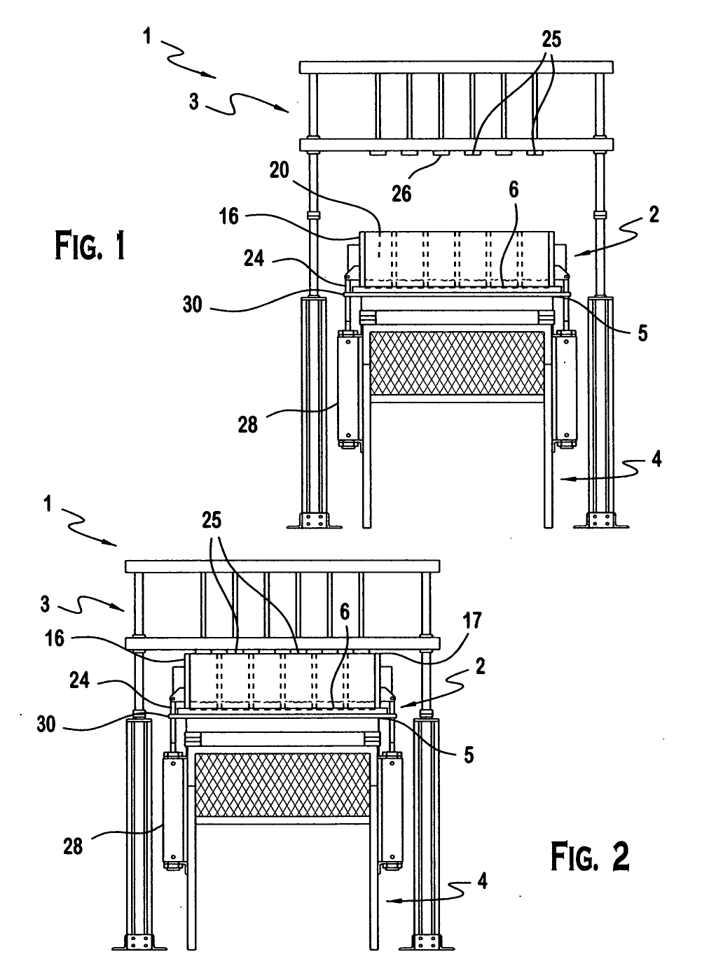

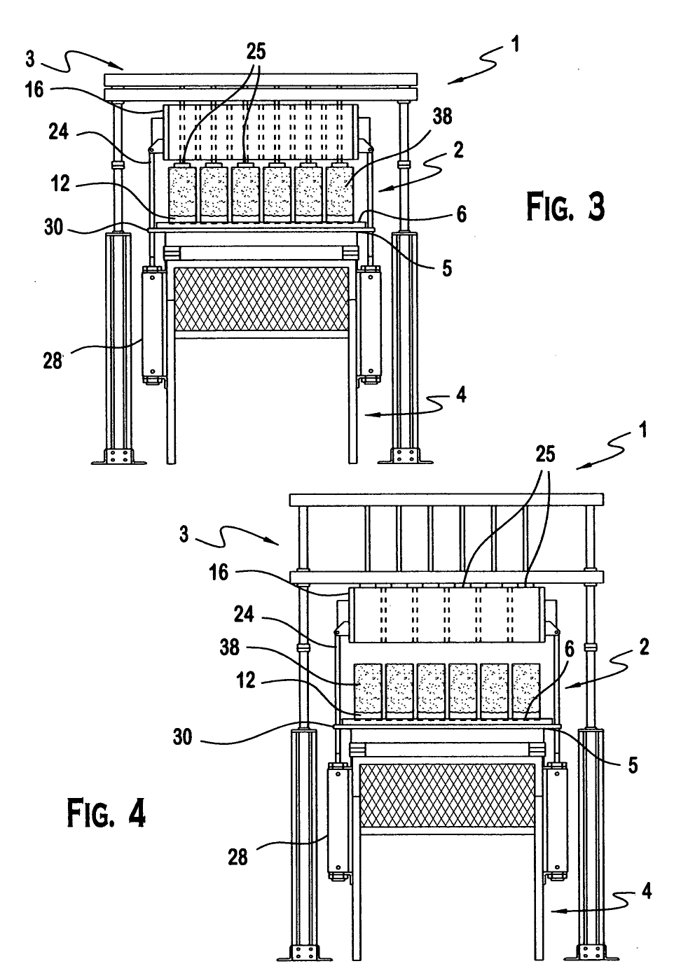

FIG. 1 to FIG. 4 show a front perspective of a decorative concrete making machine 1 according to one embodiment of the second aspect of the invention. In this embodiment of the invention, the machine 1 has a top assembly 3 and a bottom assembly 2. In FIG. 1, the top assembly 3 has a set of six plungers 25, each of which is suspended above a mold box chamber 20. Each of the plungers 25 has a bottom surface 26. The plungers 25 are connected to a mechanical device 29 (see FIG. 6) which is able to raise or lower the plungers 25, so that they can sit above, on, or in, the mold box chambers 20. In this embodiment, the bottom assembly 2 has a vibration table 4 having a top surface 5, upon which is resting an anchor plate 30. The anchor plate 30 is bolted to the vibration table 4. A base plate 6 is resting upon the anchor plate 30. Two pneumatic cylinders 28 have pistons 24 to raise or lower the mold box 16. In FIG. 1, the mold box 16 is in the lowered position, resting upon the base plate 6. FIG. 2. is the same as FIG. 1, except that the plungers 25 are in the lowered position, with the bottom surface of each plunger 26 situated slightly within a mold box chamber 20. FIG. 3. is the same as FIG. 2, except that it shows that a concrete mix has been placed on liners 12 in each of the mold box chambers 20 and caused to vibrate using the vibration table 4, while pressurized gas (in this embodiment, air) was directed to the concrete mix, resulting in the formation of six molded concrete blocks 38. Also, in FIG. 3, the plungers 25 have remainded in the lowered position, holding down the molded concrete blocks 38, while the mold box 16 has been raised, exposing the molded concrete blocks 38. FIG. 4. is the same as FIG. 3, except that both the the mold box 16 and the plungers 25 have been raised so that they are suspended above the concrete blocks 12 resting on the base plate 6.

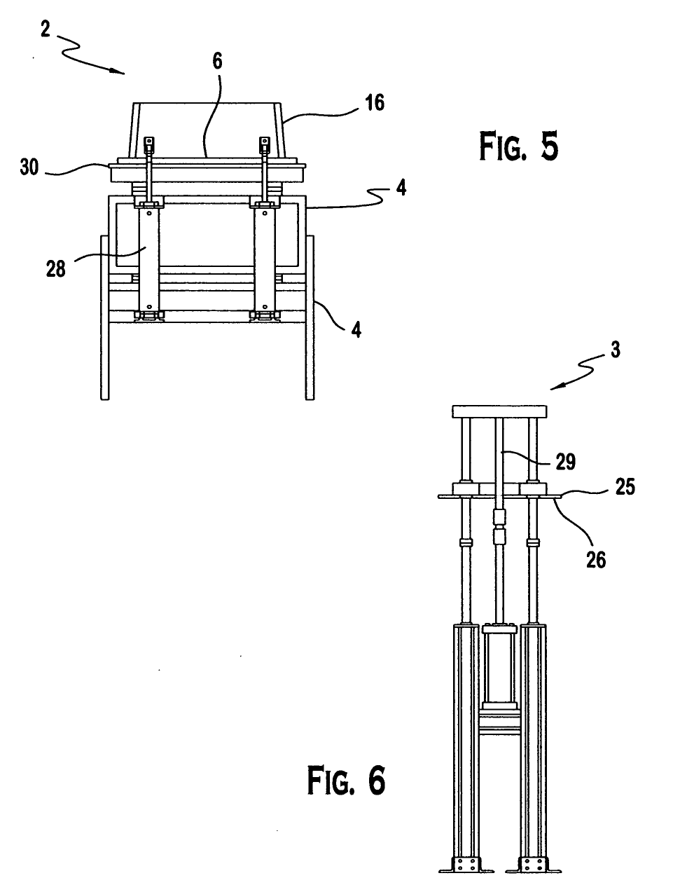

FIG. 5 and FIG. 6 show a side perspective of a concrete making machine bottom assembly 2 and top assembly 3 respectively, according to one embodiment of the second aspect of the invention. As shown in FIG. 5., in this embodiment of the invention, the mold box 16 of the bottom assembly 2 is in the lowered position, resting upon the base plate 6. Below the base plate 6 is an anchor plate 30, which rests on the vibration table 4. Attached to the side of the vibration table 4 are two pneumatic cylinders 28, each of which has a piston 24 (see FIG. 1) to raise or lower the mold box 16. In FIG. 6, the plunger 25 having a plunger bottom surface 26 has been lifted by a mechanical device 29.

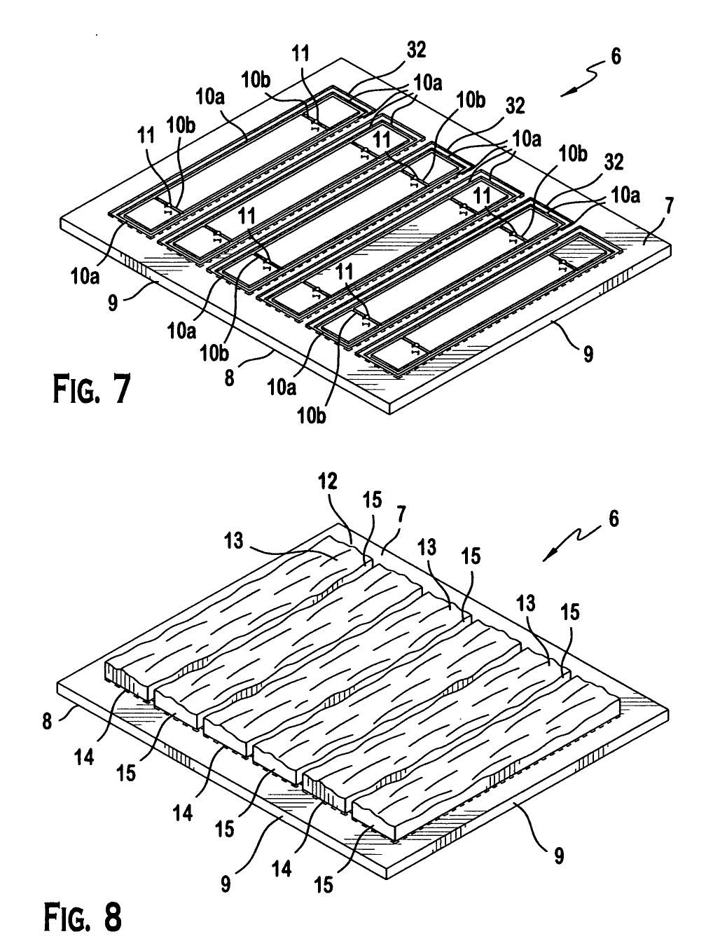

FIGS. 7-11 show, among other things, a unique manner by which, in one embodiment of the invention, positive or pressurized air 23 may be delivered to the mold box chamber 20 through the bores of the vibration table, the bores of the anchor plate 31, the bores the base plate 11, and the bores in the chamber box walls 35.

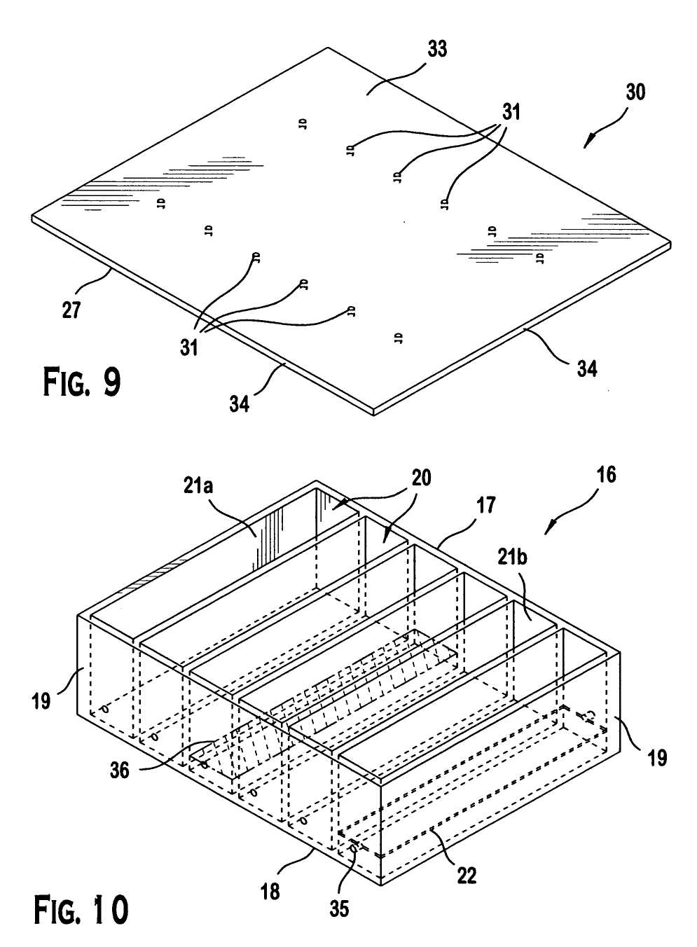

FIG. 7 shows a top elevated view of a base plate 6, according to one embodiment of the second aspect of the invention. In this embodiment, the base plate 6, which has a top surface 7, a bottom surface 8, and four side surfaces 9, is removable. The top surface 7 of the base plate 6 has six recesses 32 each having a shape and size that is substantially the same as the shape and size of the liner bottom surface 14 (see FIG. 8). The recesses 32 provide a guide which enables quick and easy correct placement of the liners 12 (see FIG. 8), and they also help to hold the liners 12 in place. The recesses 32 are oriented such that when the base plate 6 bearing the liners is placed under the mold box 16, each liner 12 will enter a separate mold box chamber 20. The base plate top surface 7 also has multiple grooves 10 (outer grooves 10a and inner grooves 10b) for transporting air around the top surface of the base plate 6. The grooves 10 are located inside each recess 32. The outer grooves 10a mirror the shape of the border of the liner bottom surface 14 (see FIG. 8.), except that they are shorter in length than the liner bottom surface 14 border. Within each recess 32 are two base plate bores 11 running from the base plate top surface 7 to the base plate bottom surface 8. Each base plate bore 11 is connected by two inner grooves 10b to the outer grooves 10a.

FIG. 8 shows a top elevated view of a base plate 6 having six liners 12 on the base plate top surface 7, according to one embodiment of the second aspect of the invention. In this embodiment, each liner 12 has a top surface 13, a bottom surface 14, and four side surfaces 15. The liner top surface 13 bears the reverse pattern of a natural rock. Each liner 12 sits within a base plate top surface recess 32 (See FIG. 7).

FIG. 9 shows a top elevated view of an anchor plate 30, according to one embodiment of the second aspect of the invention. In this embodiment, the anchor plate 30 has a top surface 33, a bottom surface 27, and four side surfaces 34. The anchor plate top surface 33 has twelve anchor plate bores 31 running from the anchor plate top surface 33 to the anchor plate bottom surface 27.

FIG. 11 shows an exploded view depicting how, in one embodiment of the invention, the anchor plate 30, base plate 6, liners 12, concrete blocks 38, and mold box 16 may be arranged. In this embodiment, the removable base plate 6 rests upon a fixed anchor plate 30. The center of the circumference of each anchor plate bore 31 is situated in the same location on the anchor plate 30 as the center of the circumference of a base plate bore 11 so that when the base plate 6 is rested upon the anchor plate 30, each base plate bore 11 is in alignment with an anchor plate bore 31. In this embodiment, the anchor plate bores 31 are smaller than the base plate bores 11. The anchor plate 30 is bolted to a vibration table 4 (see FIG. 1 to FIG. 4). The vibration table 4 also has bores (not shown) which vibration table bores are aligned with the anchor plate bores 31 and the base plate bores 11. This arrangement enables transportation of pressurized air into the vibration table bores, through the anchor plate bores 31, and then through the base plate bores 11, for distribution along the liner 12 surfaces. In this embodiment, the mold box 16 sits on the base plate 6. Within each mold box chamber 20 is a concrete block 38 resting upon a liner 12.

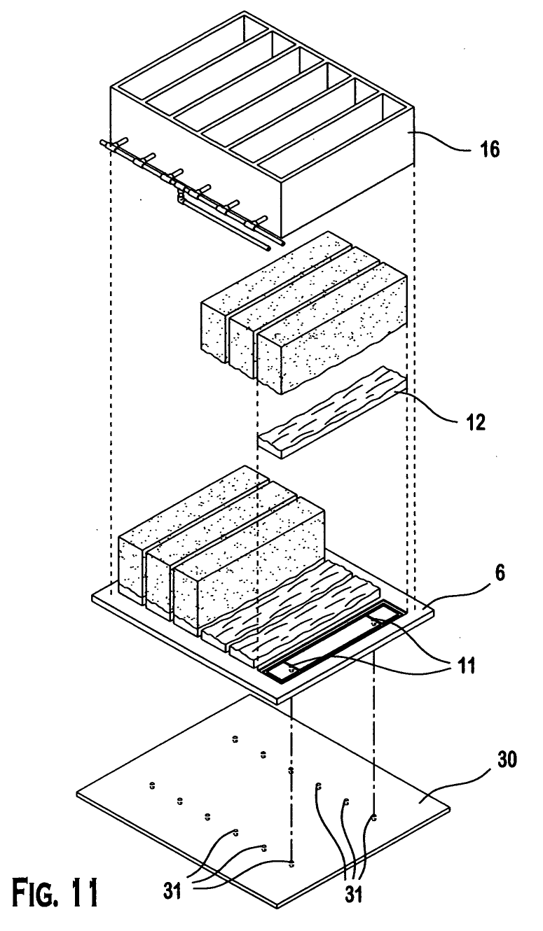

FIG. 10 shows a side elevated view of a mold box 16 according to one embodiment of the second aspect of the invention. In this embodiment, the mold box 16 has a top surface 17, a bottom surface 18, and four side surfaces 19. The mold box 16 contains six chambers 20 running from the mold box top surface 17 to the mold box bottom surface 18. The length and the width of the mold box chambers 20 do not vary along the width of the mold box 16. As a result, when a concrete mix is placed in the mold box chamber 20, the resulting concrete block has a decorative front face whose height is the same as the concrete block back face. Each mold box chamber 20 has four chamber walls 21 (two walls 21a opposing each other, and two other walls 21b opposing each other). Each chamber 20 has a chamber horizontal plane 36 having a horizontal plane surface area. Each chamber wall 21 has a chamber wall groove 22 running horizontally along the length of the chamber wall 21. The chamber wall grooves 22 are situated in a location where they would be in contact with a liner 12 (see FIG. 8), when the liner 12 is placed in the mold box chamber 20, in preparation for formation of a concrete block in the mold box chamber 20. In each chamber 20, two of the chamber walls 21b have bores 35 extending from the chamber wall 21 to the side surface of the mold box 19. Each bore 35 is connected to a chamber wall groove 22.

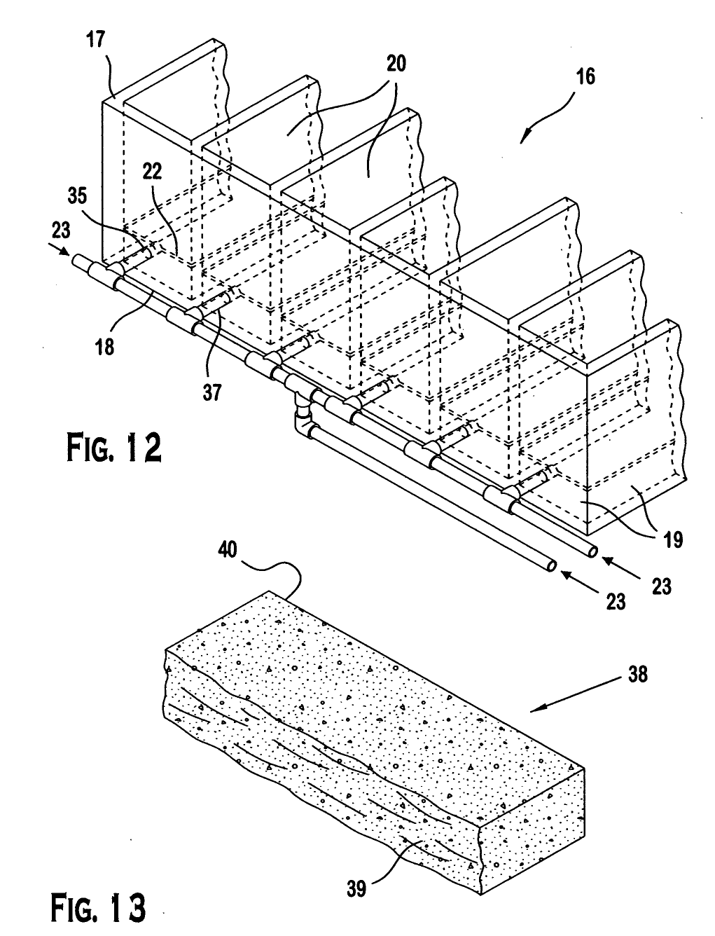

FIG. 12 shows a side elevated perspective of a mold box 16 according to one embodiment of the second aspect of the invention. In this embodiment, the mold box 16 has a top surface 17, a bottom surface 18, and four side surfaces 19. There are six chambers 20 in the mold box 16. According to one embodiment of the first aspect of the invention, after the base plate 6 (see FIG. 8) bearing the liners 12 (see FIG. 8), has been placed under the mold box 16 and the mold box 16 has been lowered onto the base plate 6 (see FIG. 1), a concrete mix is poured into each of the mold box chambers 20, where it is caused to vibrate by the vibration table 4 whereupon the concrete mix forms a molded concrete block 38 (see FIG. 13). In this embodiment, the face of the molded concrete block 38 that rests upon the liner 12 is the concrete block's decorative front face 39 (see FIG. 13). The opposite face of the molded concrete block, which faces upwards toward the mold box top surface 17, is the concrete block back face 40 (see FIG. 13). According to the present embodiment of the second aspect of the invention, since the mold box chamber walls 21 do not have a tapered draft, they result in a concrete block 38 having a front face 39 whose height is the same as the concrete block back face 40, in other words, they result in a mold box 16 having a frontal taper of zero degrees. Since the mold box chambers 20 do not have a tapered draft, and since the vibration removes and transfers most of the embodied air to the top of the concrete block 38, a strong and forceful vacuum is formed between the liner 12 and the surfaces with which the liner 12 is in contact. According to the present embodiment of the first aspect of the invention, positive air 23 is introduced to break this vacuum. According to the present embodiment of the second aspect of the invention, each mold box chamber 20 has bores 35 extending from the chamber wall 21 (see FIG. 12) to the side surface of the mold box 19. Leading to each chamber bore 35 is an air supply line 37 which transports pressurized air 23 to the bore 35 from pressurized air supplying equipment. According to the present embodiment of the first aspect of the invention, the positive or pressurized air 23 that has been transported to the liners 12 via the mold box chamber walls 21 and the base plate bores 11 (see FIGS. 7, 10, and 12), is diffused by the liners 12 so that an even distribution of positive pressure circulates below, around and above the liners 12 to release the vacuum lock on the concrete blocks. The base plate grooves 10a and 10b (see FIG. 7) assist with the even distribution of the pressurized air 23. The plungers 25 are lowered so that the bottom of each plunger 25 sits slightly within a mold box chamber 20. The mold box 16 is lifted off of the base plate 6 by the pistons 24 of the pneumatic cylinders 28 (see FIGS. 3 and 4), releasing the molded concrete blocks and the liners 12. As the mold box 16 is lifted, the plungers 25 (see FIGS. 2 and 3) hold the molded concrete blocks down so that they do not rise with the mold box 16. The base plate 6 bearing the concrete blocks 38 and liners 12 is rolled onto a conveyor belt and a new base plate 6 with liners 12 is inserted under the mold box 16. The unique use in this embodiment, of multiple base plates 6 for transportation of the liners 12 and concrete blocks 38, and the provision of pressurized air 23 simply by aligning the bores of the vibration table, anchor plate, and base plate, among other things, provide for an efficient method to manufacture decorative concrete blocks 38. Since the multiple base plates 6 are easy to clean, they can be quickly and easily reused.

What is claimed is:

1. A method for making decorative concrete blocks, said method comprising the steps of:
(i) providing at least one mold box comprising at least one chamber, the chamber having a horizontal plane which horizontal plane has a horizontal chamber surface area;
wherein said mold box has a top surface, a bottom surface and at least one side surface;
(ii) placing at least a portion of at least one liner in said chamber
wherein said liner comprises a top surface, a bottom surface, at least one side surface, and a horizontal plane, which horizontal plane has a horizontal liner surface area,
wherein the top surface of said liner is below the top surface of said mold box;
(iii) providing a base plate comprising a top surface, a bottom surface and at least one side surface;
(iv) contacting at least a portion of the bottom surface of said mold box with at least a portion of the top surface of said base plate;
(v) placing a dry-cast concrete mix in said chamber to form an unmolded concrete block comprising a top surface, bottom surface, and at least one side surface;
(vi) causing said mold box to vibrate;
(vii) contacting pressurized gas with at least one of, at least a portion of the bottom surface of said liner, or at least a portion of at least one side surface of said liner;
(viii) removing said molded concrete block from said mold box; and
(ix) curing or allowing to cure said molded concrete block to form at least one cured concrete block.

2. The method according to claim 1, wherein at least a portion of the bottom surface of said base plate is in contact with at least a portion of at least one anchor plate, said anchor plate comprising a top surface, a bottom surface and at least one side surface.

3. The method according to claim 1 wherein at least a portion of the bottom surface of said base plate is in contact with at least a portion of a top surface of a vibration table.

4. The method according to claim 2 wherein at least a portion of the bottom surface of said anchor plate is in contact with at least a portion of the top surface of said vibration table.

5. The method according to claim 1 wherein said liner comprises of a material selected from the group consisting of rubber, latex, fiberglass and polyester resin.

6. The method according to claim 1 wherein said concrete mix has a slump of no greater than one inch.

7. The method according to claim 1, wherein said concrete mix comprises a mixture of cement, aggregate and water.

8. The method according to claim 7, wherein said concrete mix further comprises at least one additive.

9. The method according to claim 1, wherein said pressurized gas has a pressure of from 50 to 150 psi.

10. The method according to claim 1, wherein said method further includes the step of providing a plunger comprising a bottom surface

11. A decorative concrete block making machine, said machine comprising a bottom assembly,
wherein said bottom assembly comprises:
(i) a vibration table comprising a top surface, a bottom surface, and at least one side surface;
(ii) a base plate comprising a top surface, a bottom surface, and at least one side surface,
wherein at least a portion of said base plate bottom surface is capable of contacting with at least a portion of the top surface of said vibration table,
wherein said base plate comprises at least one bore extending from at least one of said base plate bottom surface or said base plate side surface to said base plate top surface, and
wherein said base plate top surface comprises at least one base plate groove;
(iii) at least one mold box comprising a top surface, a bottom surface and at least one side surface,
wherein at least a portion of said bottom surface of said mold box is capable of being contacted with at least a portion of the top surface of said base plate,
wherein said mold box comprises at least one chamber, the chamber having a horizontal plane, which horizontal plane has a horizontal chamber surface area,
(iv) at least one device capable of contacting at least a portion of the bottom surface of said mold box with at least a portion of the top surface of said base plate,
(v) at least one liner comprising a top surface, a bottom surface and at least one side surface,
wherein at least a portion of the bottom surface of said liner is capable of contacting with at least a portion of the top surface of said base plate,
(vi) at least one pressurized gas supplying equipment capable of providing pressurized gas which pressurized gas is capable of contacting with at least a portion of at least one of, at least one side surface, or the bottom surface, of said liner.

12. The machine according to claim 11, wherein said machine further comprises a top assembly, wherein said top assembly comprises at least one plunger comprising a bottom surface and at least one side surface, said bottom surface comprising a bottom surface area,
wherein said plunger bottom surface is capable of at least one of (1) being suspended above said mold box, (2) being contacted with at least a portion of the top surface of said mold box, and (3) being positioned within said mold box chamber.

13. The machine according to claim 11, wherein said base plate is fixed.

14. The machine according to claim 11, wherein said liner is comprised of a material selected from the group consisting of rubber, fiberglass, and polyester resin.

15. The machine according to claim 11, where said bottom assembly further comprises an anchor plate between said vibration table and said base plate,
wherein said anchor plate comprises a top surface, a bottom surface, and at least one side surface, and
wherein said anchor plate comprises at least one bore extending from at least one of, said anchor plate bottom surface, or said anchor plate side surface, to said anchor plate top surface.

16. The machine according to claim 15, wherein said anchor plate is fixed.

17. The machine according to claim 15, wherein said base anchor bore is aligned with said base plate bore.

18. The machine according to claim 15, wherein said vibration table comprises at least one vibration table bore.

19. The machine according to claim 18, wherein said vibration table bore is aligned with said anchor plate bore and said base plate bore.
